(19) United States
(12) Patent Application Publication
(10) Pub. No.: US 2010/0103560 A1
(43) Pub. Date: Apr. 29, 2010

(54) HEAD SLIDER

(75) Inventors: Takahiro Imamura, Kawasaki (JP); Hiroyuki Kubotera, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/564,496

(22) Filed: Sep. 22, 2009

(30) Foreign Application Priority Data
Oct. 28, 2008 (JP) 2008-276555

(51) Int. Cl. G11B 5/60

(52) U.S. Cl. 360/234.3; G9B/5.229

(57) ABSTRACT

According to one embodiment, a head slider includes a slider main body, an element embedded film, a head element, and a plurality of recesses. The head element is embedded in the element embedded film. The recesses are distributed in a predetermined area formed on the trailing end surface of the element embedded film.

### CROSS-REFERENCE TO RELATED APPLICATIONS

This application is based upon and claims the benefit of priority from Japanese Patent Application No. 2008-276555, filed Oct. 28, 2008, the entire contents of which are incorporated herein by reference.

### BACKGROUND

1. Field

One embodiment of the invention relates to a head slider of a storage device.

2. Description of the Related Art

For example, in HDD, as the recording density increases, the floating height of the head slider defined from the surface of the magnetic disk decreases. As a result, for example, the head slider vibrates and comes into contact with the surface of the magnetic disk. Then, lubricant on the magnetic disk adheres to a medium opposing surface of the head slider. Further, lubricant evaporated from the magnetic disk adheres to the medium opposing surface. The adhering lubricant flows onto an air outflow side end surface, or the trailing end surface of the head slider with the existence of air flow. To eliminate such lubricant, for example, a heat generating element is embedded in the head slider. Heat from the heat generating element is used to accelerate evaporation of the lubricant. Reference may be raised, for example, Japanese Patent Application Publication (KOKAI) No. H8-279120, Japanese Patent Application Publication (KOKAI) No. 2003-109340, Japanese Patent Application Publication (KOKAI) No. H8-87847, Japanese Patent Application Publication (KOKAI) No. H11-203651, Japanese Patent Application Publication (KOKAI) No. 2001-357510, and Japanese Patent Application Publication (KOKAI) No. 2008-181627.

As for such head sliders, lubricant flows from the medium opposing surface onto the trailing end surface, and the lubricant gathers on the trailing end surface along the edge line defined by the trailing end surface and the medium opposing surface. Then, the lubricant on the trailing end surface grows into large lumps. Such large lubricant lumps take substantially long time to evaporate. As a result, the lubricant lumps may fall onto the surface of the magnetic disk and contaminate the surface of the magnetic disk and eventually may disturb stable floating of the head slider and affect the reliability of the products with such sliders.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of an inside structure of a hard disk drive (HDD) as an example of a storage device according to an embodiment of the invention;

FIG. 2 is an exemplary enlarged perspective view of a flying head slider according to the embodiment;

FIG. 3 is an exemplary enlarged back view of the trailing end surface of a flying head slider according to a first embodiment of the invention;

FIG. 4 is an exemplary partial enlarged cross sectional view taken along the line 4-4 of FIG. 3;

FIG. 5 is an exemplary enlarged back view of the trailing end surface of a flying head slider according to a second embodiment of the invention;

FIG. 6 is an exemplary partial enlarged cross sectional view taken along the line 6-6 of FIG. 5;

FIG. 7 is an exemplary enlarged back view of the trailing end surface of a flying head slider according to a third embodiment of the invention;

FIG. 8 is an exemplary enlarged back view of the trailing end surface of a flying head slider according to a fourth embodiment of the invention;

FIG. 9 is an exemplary enlarged back view of the trailing end surface of a flying head slider according to a fifth embodiment of the invention;

FIG. 10 is an exemplary enlarged back view of the trailing end surface of a flying head slider according to a sixth embodiment of the invention; and

FIG. 11 is an exemplary enlarged perspective view of a flying head slider according to a modification of the sixth embodiment.

### DETAILED DESCRIPTION

Various embodiments according to the invention will be described hereinafter with reference to the accompanying drawings. In general, according to one embodiment of the invention, a head slider comprises a slider main body, an element embedded film, a head element, and a plurality of recesses. The head element is embedded in the element embedded film. The recesses are distributed in a predetermined area formed on the trailing end surface of the element embedded film.

According to another embodiment of the invention, a head slider comprises a slider main body, an element embedded film, a head element, and a plurality of projections. The head element is embedded in the element embedded film. The projections are distributed in a predetermined area formed on the trailing end surface of the element embedded film. The projections are configured to be adjacent to each other to define a flow path for lubricant.

According to another embodiment of the invention, a head slider comprises a slider main body, an element embedded film, a head element, and a groove. The head element is embedded in the element embedded film. The groove is formed inside the periphery of the trailing end surface of the element embedded film. The groove is configured to define a flow path for lubricant.

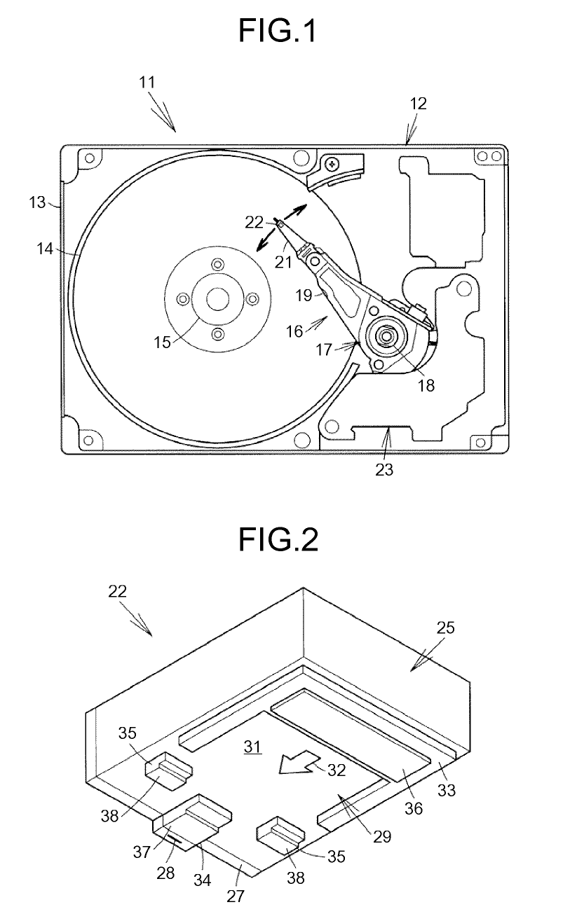

FIG. 1 schematically illustrates an inside structure of a hard disk drive (HDD) 11 as one specific example of a storage device according to an embodiment of the invention. The HDD 11 comprises a housing 12. The housing 12 has a box-shaped base 13 and a cover (not illustrated). The base 13 defines, for example, a flat, rectangular parallelepiped internal space, or storage space. The base 13 may be formed by casting of a metal material such as Al (aluminum). The cover is connected to an opening of the base 13. The storage space between the cover and the base 13 is closed hermetically. For example, the cover may be made of a metal sheet by press working.

In the storage space, at least one magnetic disk 14 is enclosed as a storage medium. The magnetic disk 14 is mounted on a rotor hub of a spindle motor 15. The spindle motor 15 can rotate the magnetic disk 14 at high speed, such as 3,600 rpm, 4,200 rpm, 5,400 rpm, 7,200 rpm, 10,000 rpm, or 15,000 rpm. For example, the magnetic disk 14 is configured as a perpendicular magnetic recording disk. In other words, the easy magnetization axis of a magnetic recording film on the magnetic disk 14 is set in the direction perpendicular to the surface of the magnetic disk 14.

In the storage space, a carriage 16 is also provided. The carriage 16 comprises a carriage block 17, which is rotatably connected to a pivot shaft 18 extending in the vertical direction from the housing 12. In the carriage block 17, a plurality of carriage arms 19 is defined extending perpendicular to the pivot shaft 18. For example, the carriage block 17 may be made of Al (Aluminum) by extrusion and gang cutter milling.

Attached to the end of each of the carriage arms 19 is a head suspension 21. The head suspension 21 extends frontward from the end of the carriage arm 19. The head suspension 21 has a flexure attached thereto. At the end of the head suspension 21, a gimbal is defined in the flexure. On the gimbal, the head slider, or equivalently, a flying head slider 22 is mounted. With the operation of the gimbal, the flying head slider 22 can follow the surface vibration and waviness of the magnetic disk 14 and change the attitude relative to the head suspension 21. On the flying head slider 22, an electromagnetic transducer element is mounted as the head element.

When air flow is generated between the surface of the magnetic disk 14 and the medium opposing surface of the flying head slider 22 by rotation of the magnetic disk 14, the air flow acts so that the positive pressure, or equivalently buoyant force, and the negative pressure, equivalently down force, act on the medium opposing surface of the flying head slider 22. At a flying height, where the buoyant force balances the sum of the down force and a pressing force of the head suspension 21 downward to the magnetic disk, the flying head slider 22 can be kept flying stably with substantially high stiffness during rotation of the magnetic disk 14.

To the carriage block 17, for example, a power source such as a voice coil motor (VCM) 23 is connected. The action of the VCM 23 rotates the carriage block 17 around the pivot shaft 18. Such rotation of the carriage block 17 is a basis to realize swinging of the carriage arm 19 and the head suspension 21. When the carriage arm 19 swings around the pivot shaft 18 while the flying head slider 22 is flying, the flying head slider 22 can move substantially along the radial direction of the magnetic disk 14. Consequently, the electromagnetic transducer element on the flying head slider 22 can come across the data zone between innermost recording track and the outermost recording track. Then, the electromagnetic transducer element on the flying head slider 22 can be positioned on a target recording track.

FIG. 2 illustrates the flying head slider 22 according to a first embodiment of the invention. The flying head slider 22 has a slider main body 25. The slider main body 25 has a base material formed into a flat rectangular parallelepiped. On the trailing end surface of the slider main body 25, an insulating nonmagnetic film or an element embedded film 27 is deposited. An electromagnetic transducer element 28 is embedded in the element embedded film 27.

The slider main body 25 is made of hard nonmagnetic material such as Al203-TiC (altic). The element embedded film 27 is made of insulating nonmagnetic material such as Al203 (Alumina). The slider main body 25 faces the magnetic disk 14 at a medium opposing surface 29. On the medium opposing surface 29, a flat base surface 31 is provided as a base recess surface. When the magnetic disk 14 rotates, air flow 32 acts on the medium opposing surface 29 from the front end to the back end of the slider main body 25.

On the medium opposing surface 29, one front rail 33 is formed on the base surface 31 on the upstream of the air flow 32 or the leading side. The front rail 33 extends along the leading end of the base surface 31 in the width direction of the slider. Likewise, on the medium opposing surface 29, a rear center rail 34 is formed elevated from the base surface 31 at the trailing, downstream side of the air flow 32. The rear center rail 34 is arranged at the center position of the slider width direction. The rear center rail 34 leads to the element embedded film 27. On the medium opposing surface 29, a horizontal pair of rear side rails 35, 35 is further formed. The rear side rails 35 stand up from the base surface 31 along the side ends of the slider main body 25 close to the trailing end. The rear center rail 34 is arranged between the rear side rails 35, 35. Each of the rear side rails 35, 35 is not necessarily formed symmetrical relative to the anteroposterior center line of the slider main body 25.

On the top surfaces of the front rail 33, the rear center rail 34 and the rear side rails 35, 35, air bearing surfaces (ABS) 36, 37, 38, 38 are defined. Upstream ends of the ABSs 36, 37, 38, 38 are connected by steps to the top surfaces of the front rail 33, the rear center rail 34, and the rear side rails 35, 35, respectively. When the air flow 32 is received on the medium opposing surface 29, relatively large positive pressure, i.e., buoyant force, is generated on the ABSs 36, 37 and 38 with the existence of the steps. Besides, a large negative pressure, i.e., down force, is generated at the downstream side, or backside of the front rail 33. The balance between these buoyant force and down force is used as a basis to establish flying height and attitude of the flying head slider 22. Incidentally, the form of the flying head slider 22 is not limited to this.

On the downstream side of the ABS 37, the electromagnetic transducer element 28 is embedded in the rear center rail 34. The electromagnetic transducer element 28 has, for example, a reading element and a writing element. The reading element uses a tunnel junction magnetic resistance effect (TuMR) element. When the TuMR element is used, resistance change of the tunnel junction film is caused in accordance with the direction of the magnetic field operated by the magnetic disk 14. This resistance change is utilized to read information from the magnetic disk 14. The writing element uses a magnetic recording head like a so-called single magnetic pole head. The single magnetic pole head generates a recording magnetic field by the electromagnetic effect of the thin film coil pattern. The recording magnetic field acts to write information in the magnetic disk 14. The electromagnetic transducer element 28 has a reading gap of the reading element and a writing pole of the writing element on the element embedded film 27.

On the downstream side of the ABS 37, a hard protective film may be formed on the surface of the element embedded film 27. Such a hard protective film covers the reading gap and writing pole exposed on the surface of the element embedded film 27. The protective film may be, for example, diamond-like carbon (DLC).

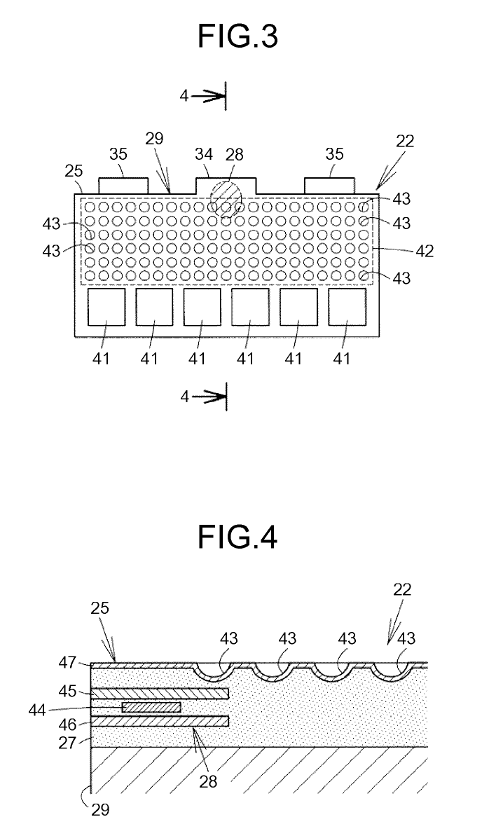

FIG. 3 schematically illustrates the trailing end surface of the flying head slider 22 of the first embodiment. For example, six conductive terminals 41 are formed on the trailing end surface. Each of the conductive terminals 41 is connected to a conductive pad formed on the head suspension 21 by, for example, bonding. The conductive terminals 41 are made of, for example, a conductive material of Au (gold). Two of the conductive terminals 41 in a pair are connected to a heat generating element described later. The conductive terminals 41 in another pair are connected to the reading element. The conductive terminals 41 in the other pair are connected to a thin film coil pattern of the writing element. The connection is made by wiring pattern formed in the element embedded film 27.

The conductive terminals 41 are arranged close to each other on the trailing end surface of the element embedded film 27 On the trailing end surface, for example, a square area 42 is defined between the medium opposing surface 29 side and the conductive terminals 41. The area 42 is defined inside the periphery of the trailing end surface. The area 42 contains, at least partially, a projection area for the electromagnetic transducer element 28 defined on the trailing end surface. The area 42 has a plurality of recesses 43 formed therein. The recesses 43 are distributed evenly into a matrix in the area 42. The recesses 43 are each formed into, for example, a hemispherical shape or a trench rounded at the bottom. For example, PFPR (perfluoropolyether) is used for the lubricant. The diameter and depth of each of the recesses 43 are set at, for example, about several μm.

As illustrated in FIG. 4, in the element embedded film 27, a heat generating element 44 is embedded adjacent to electromagnetic transducer elements 48. The heat generating element 44 is arranged, for example, between a writing element 45 and a reading element 46. The heat generating element 44 is formed of heating wire. The heating wire may be, for example, W (tungsten) and TiW (titanium tungsten). The heating wire generates heat in accordance with supplied power. The thin film coil pattern of the writing element 45 is expanded based on the heat of the heating wire. As a result, the front end of the thin film coil pattern protrudes on the surface of the element embedded film 27, which is a so-called thermal protrusion. Thus, the electromagnetic transducer element 28 is displaced toward the magnetic disk 14. That is, the heat actuator is made. The floating height of the electromagnetic transducer element 28 is determined in accordance with the projection amount.

On the trailing end surface of the element embedded film 27, a cover film 47 is preferably formed. The cover film 47 may be formed for example over the entire surface of the trailing end surface. The cover film 47 is also formed in the recesses 43. The cover film 47 has surface free energy higher than the surface free energy of the alumina of the element embedded film 27. The cover film 47 may be, for example, DLC film or metal film. To form the recesses 43, for example, ion milling may be performed on the trailing end surface of the element embedded film 27. In forming the cover film 47, sputtering may be performed on the trailing end surface of the element embedded film 27. On the trailing end surface, the conductive terminals 41 are formed after forming the cover film 47.

While the magnetic disk 14 rotates, for example, the flying head slider 22 sporadically comes into contact with the surface of the magnetic disk 14 by vibration of the flying head slider 22 or intentional touch down to calibrate the thermal actuator. Then, the lubricant on the magnetic disk 14 adheres to the medium opposing surface 29. Besides, the lubricant evaporates from the magnetic disk 14 and adheres to the medium opposing surface 29 even without any contact. The adhering lubricant flows, with the existence of the air flow 32, from the air outflow end of the medium opposing surface 29 onto the trailing end surface of the element embedded film 27. As the cover film 47, which has high surface free energy, is formed on the trailing end surface, the lubricant is likely to spread over the entire surface of the trailing end surface based on the surface tension. As the recesses 43 are arranged in matrix, the lubricant flows evenly over the entire surface of the trailing end surface. The thickness of the lubricant is as even as possible over the trailing end surface. Then, in the area 42, evaporation of the lubricant in the vicinity of the projection area of the electromagnetic transducer elements 28 is accelerated by heat generation of the heat generating element 44 and the electromagnetic transducer elements 28. With this evaporation, the lubricant in the projection area decreases and remaining lubricant moves toward the projection area based on the surface tension. Then, the lubricant thickness is made uniform over the area 42. Consequently, the lubricant is evaporated effectively and prevented from growing into lumps.

Besides, in the area 42, the lubricant is held in the recesses 43. With the existence of the recesses 43, the lubricant can be securely held as compared with the case where the trailing end surface is flat. The lubricant can be securely held until it is spread out or evaporated. In addition, if the flying head slider 22 moves in the radial direction of the magnetic disk 14 by swing of the carriage arm 19, the lubricant can be held reliably in the recesses 43. This reliably prevents dropping off of the lubricant onto the magnetic disk 14.

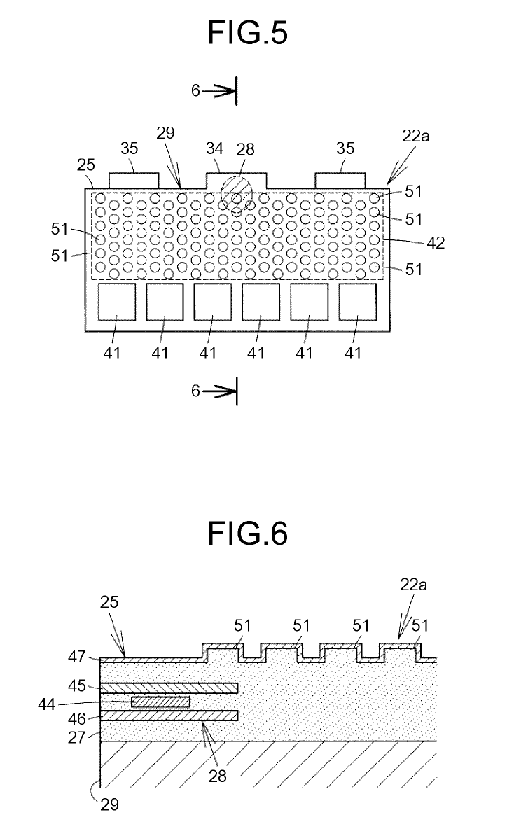

FIG. 5 schematically illustrates the trailing end surface of a flying head slider 22a according to a second embodiment of the invention. In the flying head slider 22a, a plurality of projections 51 is formed in the area 42. The projections 51 in the area 42 are distributed, for example, on the top of a regular triangle lattice. Each of the projection 51 is formed, for example, in a cylindrical shape. Between the projections 51, a flow path for the lubricant is defined. The diameter and height of each of the projections 51 are set, for example, at about several μm. As illustrated in FIG. 6, the cover film 47 is preferably formed on the trailing end surface as previously described. In forming the projections 51, for example, film forming by deposition or sputtering may be performed. Or, debris or burrs around the projections 51 may be removed by ion milling. Or, the projections 51 may be formed by plating, for example. Other parts and structures of the flying head slider are equivalent to those of the flying head slider 22 and denoted by the same reference numerals.

As for the flying head slider 22a, the lubricant is diffused over the entire surface of the trailing end surface along the flow path defined between the projections 51. As the projections 51 are arranged at the top of a regular triangle lattice, the lubricant can be diffused over the entire surface of the trailing end surface. Lubricant flows such that the thickness of the lubricant is as uniform as possible all over the entire surface of the trailing end surface. Then, by heat generation of the electromagnetic transducer elements 28 and the heat generating element 44, evaporation of the lubricant in the projection area of the electromagnetic transducer elements 28 are accelerated in the area 42. As the lubricant in the projection area decreases by evaporation, remaining lubricant moves toward the projection area based on the capillary action. Thus, the thickness of the lubricant in the area 42 is made uniform. Consequently, the lubricant evaporation can be accelerated effectively.

Besides, as compared with the case where the trailing end surface is a flat surface, the surface area of the trailing end surface is made larger e with the existence of the projections 51. As a result, more lubricant can be held on the trailing end surface. The lubricant can be securely held until it is spread out or evaporated. At the same time, the lubricant can be held reliably on the projections 51 even during swinging of the carriage arm 19. This reliably prevents dropping off of the lubricant onto the magnetic disk 14.

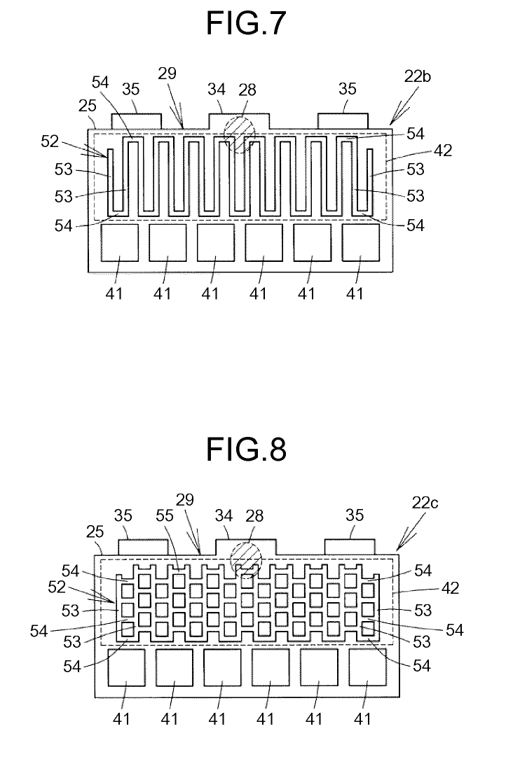

FIG. 7 schematically illustrates the trailing end surface of a flying head slider 22b according to a third embodiment of the invention. In the flying head slider 22b, a plurality of grooves 52 is formed in the area 42. The grooves 52 comprise a plurality of longitudinal grooves 53 extending in a vertical direction perpendicular to the medium opposing surface 29 and in parallel with each other and a plurality of transverse grooves 54 extending in the horizontal direction in parallel with the medium opposing surface 29. The transverse grooves 54 connect one ends to the other ends of adjacent pairs of the longitudinal grooves 53. Then, the grooves 52 are defined in the Meander Coil shape. The grooves 52 extend meandering in the width direction of the flying head slider 22b. The shape and size such as depth and diameter of each of the longitudinal grooves 53 and transverse grooves 54 are determined based on the surface tension of the lubricant on the magnetic disk 14. The depth of each of the longitudinal grooves 53 and transverse grooves 54 is set at, for example, about several μm. The width of each of the longitudinal grooves 53 and transverse grooves 54 is set at, for example, about several μm. The grooves 52 are formed by, for example, ion milling. In the same manner as described above, the cover film 47 is preferably formed on the trailing end surface of the element embedded film 27. Other parts and structures of the flying head slider are equivalent to those of the flying head slider 22 and denoted by the same reference numerals.

As for the flying head slider 22b, the lubricant is diffused by capillary action over the entire surface of the trailing end surface along the grooves 52. Thus, the grooves 52 define the flow path for the lubricant. Lubricant flows such that the thickness of the lubricant is as uniform as possible all over the entire grooves on the trailing end surface. Then, by heat generation of the electromagnetic transducer elements 28 and the heat generating element 44, evaporation of the lubricant in the projection area for the electromagnetic transducer elements 28 is accelerated in the area 42. As the lubricant in the projection area decreases by evaporation, remaining lubricant in the grooves 52 moves toward the projection area based on the capillary action. Thus, the thickness of the lubricant in the area 42 is made uniform. Consequently, the lubricant evaporation can be accelerated effectively.

Besides those, in the area 42, the lubricant is held in the grooves 52. As compared with the case where the trailing end surface is a flat surface, more lubricant can be held with the existence of the grooves 52. The lubricant can be securely held until it is spread out or evaporated. In addition, the lubricant can be held reliably in the grooves 52 even while the carriage arm 19 is swinging. This reliably prevents dropping off of the lubricant onto the magnetic disk 14. Further, as the grooves 52 are arranged inside the periphery of the trailing end surface and are not exposed to the medium opposed surface, chipping of the material at the periphery of the trailing end surface or the edge of the element embedded film 27 can be avoided. To the contrary, if the groove extends to the periphery of the trailing end surface, the edge of the element embedded film 27 is likely to be chipped or cracked and damage the reliability for products.

FIG. 8 schematically illustrates the trailing end surface of a flying head slider 22c according to a fourth embodiment of the invention. The flying head slider 22c is a modification of the flying head slider 22b described above. As for the flying head slider 22c, the longitudinal grooves 53 adjacent to each other are connected by the transverse grooves 54. Other parts and structures of the flying head slider are equivalent to those of the flying head slider 22b and denoted by the same reference numerals. As for the flying head slider 22c, in addition to the above-mentioned operational effects, with the existence of the transverse grooves 54, much more lubricant can be held in the trailing end surface. Besides, as each of the transverse grooves 54 connects an adjacent pair of the longitudinal grooves 53, the lubricant can be spread faster and reliably held in the grooves even when the flying head slider 22c moves in the radial direction of the magnetic disk 14.

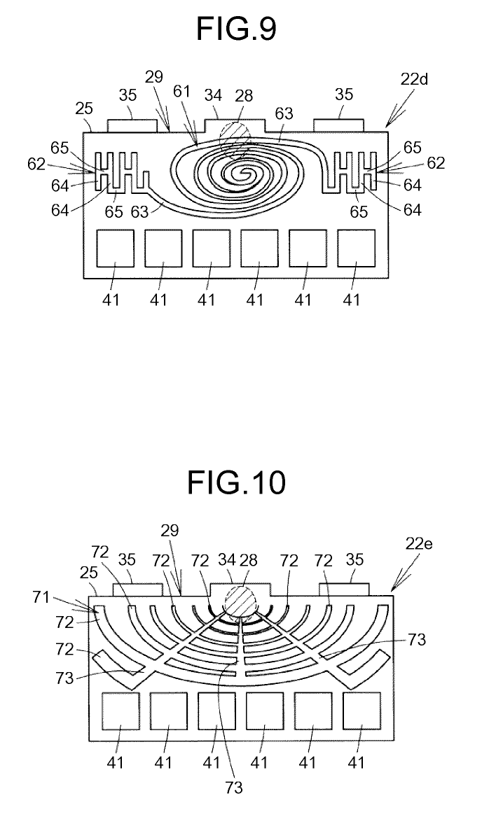

FIG. 9 schematically illustrates the trailing end surface of a flying head slider 22d according to a fifth embodiment of the invention. As for the flying head slider 22d, a plurality of grooves 61 is formed in the area 42. The grooves 61 comprise a pair of groove groups 62 formed at the both sides of the area 42 in the width direction of the flying head slider 22d and two spiral grooves 63 connecting the groove groups 62. Each of the groove groups 62 has longitudinal grooves 64 extending in a vertical direction perpendicular to the medium opposing surface 29 and in parallel with each other and a plurality of transverse grooves 65 extending in the horizontal direction in parallel with the medium opposing surface 29. The transverse grooves 65 connect adjacent the two longitudinal grooves 64. Beside those, the spiral grooves 63 extend in parallel with each other. The two spiral grooves 63 are connected to each other at the spiral center. The width of each of the spiral grooves 63 becomes narrower as the groove becomes closer to the spiral center. The spiral center is defined to be close to the projection area for the electromagnetic transducer elements 28. The depth of each of the spiral grooves 63, the longitudinal grooves 64 and the transverse grooves 65 is set at, for example, about several μm. The width of each of the spiral grooves 63, the longitudinal grooves 64 and the transverse grooves 65 is set at, for example, about several μm. The spiral grooves 63, the longitudinal grooves 64 and the transverse grooves 65 are formed, for example, by ion milling. In the same manner as described above, the cover film 47 is preferably formed on the trailing end surface of the element embedded film 27. Other parts and structures of the flying head slider are equivalent to those of the flying head slider 22 and denoted by the same reference numerals.

As for the flying head slider 22d, the lubricant is diffused by capillary action over the entire surface of the trailing end surface along the grooves 61. Thus, the grooves 61 define the flow path for the lubricant. The thickness of the lubricant is as uniform as possible all over the entire surface of the trailing end surface. Then, by heat generation of the electromagnetic transducer elements 28 and the heat generating element 44, evaporation of the lubricant in the projection area for the electromagnetic transducer elements 28 is accelerated in the area 42. As the lubricant in the projection area decreases by evaporation, remaining lubricant moves toward the projection area, or spiral center of the spiral grooves 63, based on the capillary action. Thus, the thickness of the lubricant in the area 42 is made uniform. Consequently, the lubricant evaporation can be accelerated effectively and can be prevented from growing into lumps.

Besides those, in the area 42, the lubricant is held in the grooves 61. As compared with the case where the trailing end surface is a flat surface, more lubricant can be held with the existence of the grooves 61. The lubricant can be securely held until it is spread out or evaporated. In addition, the lubricant can be held reliably in the grooves 61 even while the carriage arm 19 is swinging. This reliably prevents dropping off of the lubricant onto the magnetic disk 14. Further, as the grooves 61 are arranged inside the periphery of the trailing end surface, the periphery of the trailing end surface, or equivalently, the edge of the element embedded film 27 is prevented from being chipped or cracked when forming of the grooves 61 or in operation.

FIG. 10 schematically illustrates the trailing end surface of a flying head slider 22e according to a sixth embodiment of the invention. As for the flying head slider 22e, a plurality of grooves 71 is formed in the area 42. The grooves 71 comprise a plurality of circular-arc-shaped grooves 72 and a plurality of radial grooves 73. The circular-arc-shaped grooves 72 extend curved and concentrically about the projection area for the electromagnetic transducer element 28. Each of the circular-arc-shaped grooves 72 has the width which preferably becomes narrower as it comes closer to the projection area. The radial grooves 73 extend radially from the projection area as the center. Each of the radial grooves 73 has the width which preferably becomes narrower as it comes closer to the projection area. The depth of each of the circular-arc-shaped grooves 72 and the radial grooves 73 is set at, for example, about several μm. The width of each of the circular-arc-shaped grooves 72 and the radial grooves 73 is set at, for example, about several μm. The circular-arc-shaped grooves 72 and the radial grooves 73 are formed, for example, by ion milling. In the same manner as described above, the cover film 47 is preferably formed on the trailing end surface of the element embedded film 27. Other parts and structures of the flying head slider are equivalent to those of the flying head slider 22 and denoted by the same reference numerals.

As for the flying head slider 22e, the lubricant is diffused by capillary action over the entire surface of the trailing end surface along the grooves 71. Thus, the grooves 71 define the flow path for the lubricant. Lubricant flows such that the thickness of the lubricant is as uniform as possible all over the entire surface of the trailing end surface. Then, by heat generation of the electromagnetic transducer elements 28 and the heat generating element 44, evaporation of the lubricant in the projection area for the electromagnetic transducer elements 28 is accelerated in the area 42. As the lubricant in the projection area decreases by evaporation, remaining lubricant moves toward the projection area in the grooves 71 based on the capillary action. Thus, the thickness of the lubricant in the area 42 is made uniform. Consequently, the lubricant evaporation can be accelerated effectively.

Besides, in the area 42, the lubricant is held in the grooves 71. As compared with the case where the trailing end surface is a flat surface, more lubricant can be held with the existence of the grooves 71. The lubricant can be securely held until it is spread out or evaporated. In addition, the lubricant can be held reliably in the grooves 71 even while the carriage arm 19 is swinging. This reliably prevents dropping off of the lubricant onto the magnetic disk 14. Further, as the grooves 71 are arranged inside the periphery of the trailing end surface, the periphery of the trailing end surface, or equivalently, the edge of the element embedded film 27 is prevented from being chipped or cracked when forming of the grooves 71 or in operation.

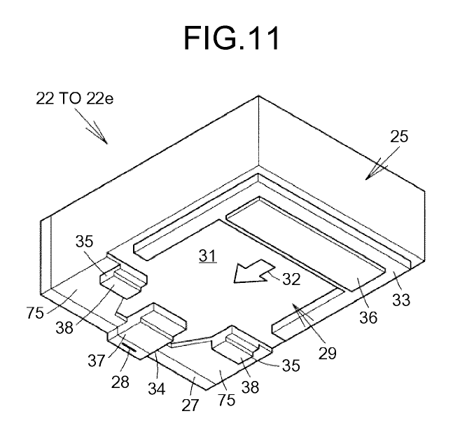

As for the flying head sliders 22 to 22e described up to this point, as illustrated in FIG. 11, a middle level surface 75 may be defined which extends, behind the rear side rails 35, 35, from the rear side rails 35, 35 to the air outflow end of the medium opposing surface 29. The middle level surface 75 is connected to the side end of the rear center rail 34. The middle level surface 75 extends at the level lower than that of the top surfaces of the rear side rails 35, 35 and the rear center rail 34. Besides, the middle level surface 75 extends at a level higher than that of the base surface 31. The middle level surface 75 is connected to the base surface 31 via steps. Other parts and structures of the flying head slider are equivalent to those of the flying head sliders 22 to 22e and denoted by the same reference numerals.

As described above, the air flow 32 acts on the medium opposing surface 29 of the flying head slider 22. The middle level surface 75 extends at the level one-step higher than that of the base surface 31 behind the rear side rails 35, 35. With this structure, stagnation of shear stress generated by the air flow 32 behind the rear side rails 35, 35 can be eliminated as much as possible. The Couette component of shear stress is increased. Consequently, the formation of lubricant lumps on the middle level surface 75 is minimized. The lubricant easily flows from the middle level surface 75 toward the trailing end surface of the element embedded film 27. The above embodiments can be suitably applied to the flying head sliders 22 to 22e.

Further, as for the flying head sliders 22 to 22e as described above, another heat generating element may be embedded in the element embedded film 27 in addition to the heat generating element 44. Such a heat generating element may extend all over the surface of the area 42 along the trailing end surface of the element embedded film 27. The heat generating element may be formed of, for example, heating wire like the heat generating element 44.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A head slider comprising:
a slider main body;
an element embedded film;
a head element embedded in the element embedded film; and
a plurality of recesses in a predetermined area formed on a trailing end surface of the element embedded film.

2. The head slider according to claim 1, further comprising a cover film formed on the trailing end surface of the element embedded film and configured to have surface free energy that is higher than surface free energy of the element embedded film.

3. The head slider according to claim 1, further comprising a heat generating element embedded in the element embedded film along the trailing end surface.

4. A storage device comprising the head slider according to claim 1.

5. A head slider comprising:
a slider main body;
an element embedded film;
a head element embedded in the element embedded film; and
a plurality of projections in a predetermined area formed on a trailing end surface of the element embedded film, the projections configured to be adjacent to each other to define a flow path for lubricant.

6. The head slider according to claim 5, further comprising a cover film formed on the trailing end surface of the element embedded film and configured to have surface free energy that is higher than surface free energy of the element embedded film.

7. The head slider according to claim 5, further comprising a heat generating element embedded in the element embedded film along the trailing end surface.

8. A storage device comprising the head slider according to claim 5.

9. A head slider comprising:
a slider main body;
an element embedded film;
a head element embedded in the element embedded film; and
at least one groove formed inside a periphery of a trailing end surface of the element embedded film, the groove configured to define a flow path for lubricant.

10. The head slider according to claim 9, further comprising a cover film formed on the trailing end surface of the slider main body and configured to have surface free energy that is higher than surface free energy of the element embedded film.

11. The head slider according to claim 9, further comprising a heat generating element embedded in the element embedded film along the trailing end surface.

12. A storage device comprising the head slider according to claim 9.
